(19) United States
(12) Patent Application Publication
(10) Pub. No.: US 2004/0073531 A1
(43) Pub. Date: Apr. 15, 2004

(54) Method, system and program product for automatically linking web documents

(75) Inventor: John F. Patterson, Carlisle, MA (US)

Correspondence Address: HOFFMAN WARNICK & D'ALESSANDRO, LLC, 3 E-COMM SQUARE, ALBANY, NY, 12207

(73) Assignee: International Business Machines Corporation, Armonk, NY

(21) Appl. No.: 10/267,295

(22) Filed: Oct. 9, 2002

(51) Int. Cl. G06F 7/00

(52) U.S. Cl. 707/1

(57) ABSTRACT

The present invention automatically links web documents to other, existing web documents. Specifically, when a web document is requested, the content therein will be compared to an index of references and addresses to determine whether any related web documents exist. If any of the content matches any of the references in the index, a related web document does exist. The address corresponding to the related web document will then be bound to the matching content of the requested web document. This process occurs before the web document is displayed to the user and alleviates the problems associated with hyperlinks to non-existing web documents.

### BACKGROUND OF THE INVENTION

1. Field of the Invention

In general, the present invention provides a method, system and program product for automatically linking web documents in a collection of web documents. Specifically, the present invention allows a request web document to be automatically linked to an existing, related web document.

2. Background Art

As the use of the World Wide Web becomes more pervasive, websites are becoming a powerful tool for the dissemination of information. For example, historical and medical websites are constantly being visited by web users in search of information. To this extent, it is common for a group of authors to collaborate in creating a collection of web documents for a website. For example, if a website directed to American colonial history is being created, one author may create a web document about the Constitution, while another author may create a web document about George Washington.

When creating a collection of web documents, it is often desirable to link the individual web documents to one another. Specifically, the content within one web document may relate to another web document in the collection. In such an event, it would be advantageous to provide the user with a hyperlink to the related web document so that the related content can be easily accessed. Unfortunately, linking web documents is not always a simple task. For example, when inserting a hyperlink into a web document, the authors must be concerned with whether the hyperlink is “active.” That is, the authors must know that the linked web document exists and that the address referred to in the hyperlink is correct. If the linked document does not exist, or the hyperlink address is not correct, the user will not be able to access the linked document. This issue becomes especially problematic for authors who are not particularly savvy in website generation and/or hyperlink technology.

Heretofore, various systems have been developed for linking web pages and content. However, no existing system provides a way for individual documents in a collection of documents to be linked based on content. Moreover, no existing system provides a way to determine whether a related document in the collection has been created before providing a hyperlink.

In view of the foregoing, there exists a need for a method, system and program product for automatically linking web documents. A further need exists for a requested web document to include a reference to a related web document. Still yet, a need exists for the capability to determine whether the related document exists by accessing an index that correlates references with addresses of web documents. An additional need exists for the reference in the requested web document to be converted into a hyperlink to the related web document, if the related document exists.

### SUMMARY OF THE INVENTION

In general, the present invention provides a method, system and program product for automatically linking web documents. Specifically, under the present invention, when a web document in a collection is created, the content therein can include one or more references to other web documents in the collection. The references generally occur naturally within the text of the web document and can pertain to the topic, name or unique identifier of another web document in the collection. When a particular web document is requested by a user, the content therein will be compared to the references in an index. The index correlates references and addresses of all web documents in the collection. If any portion of the content of the requested web document matches any of the references in the index, the matching portion of content is considered to be a “reference” to an existing, related web document. Then, the web address corresponding to the related web document will be bound to the reference in the originally requested web document. Thus, the reference in the originally requested web document will be converted into a hyperlink to an existing, related web document. This process typically occurs as the requested web page is loading so that the hyperlinks are present when the web page is displayed to the requesting user.

According to a first aspect of the present invention, a computer-implemented method for automatically linking web documents is provided. The method comprises: (1) providing a requested web document having content; (2) determining whether a related web document exists by comparing the content to an index while the requested web document is loading, wherein the index correlates references with addresses of web documents, and wherein the related web document exists if a portion of the content matches any of the references in the index; and (3) converting the matching portion of content into a hyperlink to the related web document.

According to a second aspect of the present invention, a computer-implemented method for automatically linking web documents is provided. The method comprises: (1) providing a requested web document, wherein the requested web document comprises content that includes a reference to a related web document; (2) determining whether the related web document exists by comparing the content to an index while the requested web document is loading, wherein the index correlates references with addresses of related web documents, and wherein the related web document exists if the reference in the requested web page is present in the index; and (3) converting the reference into a hyperlink to the related web document if the related web document exists, prior to displaying the requested web document.

According to a third aspect of the present invention, a system for automatically linking web documents is provided. The system comprises: (1) a document system for accessing a requested web document having content; (2) a determination system for determining whether a related web document exists by comparing the content to an index while the requested web document is loading, wherein the index correlates references with addresses of web documents, and wherein the related web document exists if any portion of the content matches any of the references in the index; and (3) a binding system for converting a matching portion of content into a hyperlink to the related web document.

According to a fourth aspect of the present invention, a program product stored on a recordable medium for automatically linking web documents is provided. When executed, the program product comprises: (1) program code for accessing a requested web document having content; (2) program code for determining whether a related web document exists by comparing the content to an index while the requested web document is loading, wherein the index correlates references with addresses of web documents, and wherein the related web document exists if any portion of the content matches any of the references in the index; and (3) program code for converting a matching portion of content into a hyperlink to the related web document.

Therefore, the present invention provides a method, system and program product for automatically linking web documents.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts a diagram of a web server having a linking system, according to the present invention.

FIG. 2A depicts an excerpt of a requested web document.

FIG. 2B depicts the excerpt of FIG. 2A after a reference has been converted into a hyperlink to a related web document.

FIG. 3 depicts a method flow diagram, according to the present invention.

The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

In general, the present invention provides a method, system and program product for automatically linking web documents. Specifically, under the present invention when a web document in a collection is created, the content therein can include one or more references to other web documents in the collection. The references generally occur naturally within the text of the web document and can pertain to the topic, name or unique identifier of another web document in the collection. When a particular web document is requested by a user, the content therein will be compared to the references in an index. The index correlates references and addresses of all web documents in the collection. If any portion of the content of the requested web document matches any of the references in the index, the matching portion of content is considered to be a “reference” to an existing, related web document. Then, the web address corresponding to the related web document will be bound to the reference in the originally requested web document. Thus, the reference in the originally requested web document will be converted into a hyperlink to an existing, related web document. This process typically occurs as the requested web page is loading so that the hyperlinks are present when the web page is displayed to the requesting user.

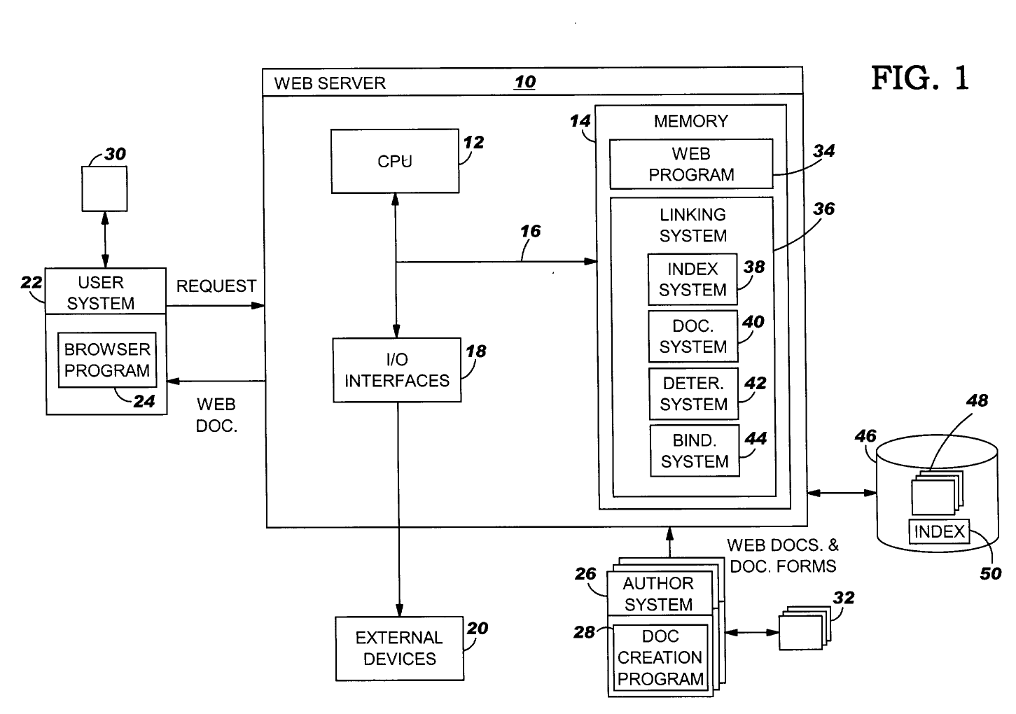

Referring now to FIG. 1, web server 10 in communication with user system 22 and author system(s) 26 is shown. As depicted, web server 10 generally includes central processing unit (CPU) 12, memory 14, bus 16, input/output (I/O) interfaces 18 and external devices/resources 20. CPU 12 may comprise a single processing unit, or be distributed across one or more processing units in one or more locations, e.g., on a client and server. Memory 14 may comprise any known type of data storage and/or transmission media, including magnetic media, optical media, random access memory (RAM), read-only memory (ROM), a data cache, a data object, etc. Moreover, similar to CPU 12, memory 14 may reside at a single physical location, comprising one or more types of data storage, or be distributed across a plurality of physical systems in various forms.

I/O interfaces 18 may comprise any system for exchanging information to/from an external source. External devices/resources 20 may comprise any known type of external device, including speakers, a CRT, LED screen, hand-held device, keyboard, mouse, voice recognition system, speech output system, printer, monitor, facsimile, pager, etc. Bus 16 provides a communication link between each of the components in web server 10 and likewise may comprise any known type of transmission link, including electrical, optical, wireless, etc. In addition, although not shown, additional components, such as cache memory, communication systems, system software, etc., may be incorporated into web server 10.

Database 46 provides storage for information under the present invention. Such information could include, for example, a collection of web documents 48, an index 50 of references and web document addresses, etc. As such, database 46 may include one or more storage devices, such as a magnetic disk drive or an optical disk drive. In another embodiment, database 46 includes data distributed across, for example, a local area network (LAN), wide area network (WAN) or a storage area network (SAN) (not shown). Database 46 may also be configured in such a way that one of ordinary skill in the art may interpret it to include one or more storage devices.

It should be understood that communication between web server 10, user system 22 and author system(s) 26 can occur via a direct hardwired connection (e.g., serial port), or via an addressable connection in a client-server (or server-server) environment. In the case of the latter, the server and client may be connected via the Internet, a wide area network (WAN), a local area network (LAN), a virtual private network (VPN) or other private network. The server and client may utilize conventional network connectivity, such as Token Ring, Ethernet, or other conventional communications standards. Where the client communicates with the server via the Internet, connectivity could be provided by conventional TCP/IP sockets-based protocol. In this instance, the client would utilize an Internet service provider to establish connectivity to the server. It should also be understood that although not shown for brevity purposes, user system 22 and author system(s) 26 typically include computerized components (e.g., CPU, memory, database, etc.) similar to web server 10.

Stored in memory 14 of web server 10 are web program 34 and linking system 36. Web program 34 is intended to be representative of any program run on a web server 10 for delivering web content to user system 22. One example of such a program is WEBSPHERE, which is commercially available from International Business Machines Corp. of Armonk, N.Y. To this extent, web program 34 can retrieve web pages or documents 48 from database 46 and transmit the same to user system 22. Linking system 36 is provided in accordance with the present invention and allows web documents in collection of documents 48 to be automatically linked. As shown, linking system 36 includes index system 38, document system 40, determination system 42 and binding system 44. The precise functionality of linking system 36 will be described in detail below.

Under the present invention, one or more authors 32 can use author system(s) 26 to create web documents for access by user 30. To this extent, authors 32 could be a group of individuals collaborating on a project, whereby each author is responsible for creating a particular web document. For example, authors 32 could be collaborating to create a collection of web documents for a historical website about colonial times. Under such an arrangement, author “A” could be responsible for creating a web document about the Declaration of Independence, while author “B” is responsible for creating a web document about George Washington. Accordingly, author system(s) 26 could include a document creation program 28 that allows for web documents to be created. Document creation program 28 could incorporate one or more known technologies such as a word processing program, a HTML editor, etc. In any event, once an author 32 has completed a web document, author 32 will transmit the created document to web server 10 for storage. Along with the web document, however, author 32 will also complete and transmit a document form (e.g., a separate web form, or a header to the completed web document), which lists “references” pertaining to the web document. The references can be any terms or values that help identify the nature of the created web document. Typical references include items such as the document name, a topic and/or a unique identifier. As will be further described below, this information will aid in the indexing of the web document. To this extent, it should be understood that author systems 26 and/or document creation program 28 should include the capability to create the document forms.

The web document and document form are received by indexing system 38. Upon receipt, indexing system 38 will store and index the web document. Specifically, once the web document is stored (e.g., in database 46), the address of the web document will be correlated in an index 50 with its references as enumerated in the document form. For example, if web document “A” was about George Washington, and author 32 listed the references of “George Washington,” “cherry tree” and “first president,” the index entry for web document “A” could resemble the following:

| REFERENCES | WEB DOCUMENT ADDRESS |
|---|---|
| GEORGE | XYZ.123 |
| WASHINGTON | |
| CHERRY | |
| TREE | |
| FIRST PRESIDENT | |

It is understood, however, that the above index is shown for illustrative purposes only and many variations are possible. For example, the index could also include information such as the author of the web document, the date of creation, etc. It is further understood that authors 32 need not maintain separate author system(s) 26 to create web documents. Rather, document creation program 28 could be loaded on web server 10, which could be directly accessed by authors 32

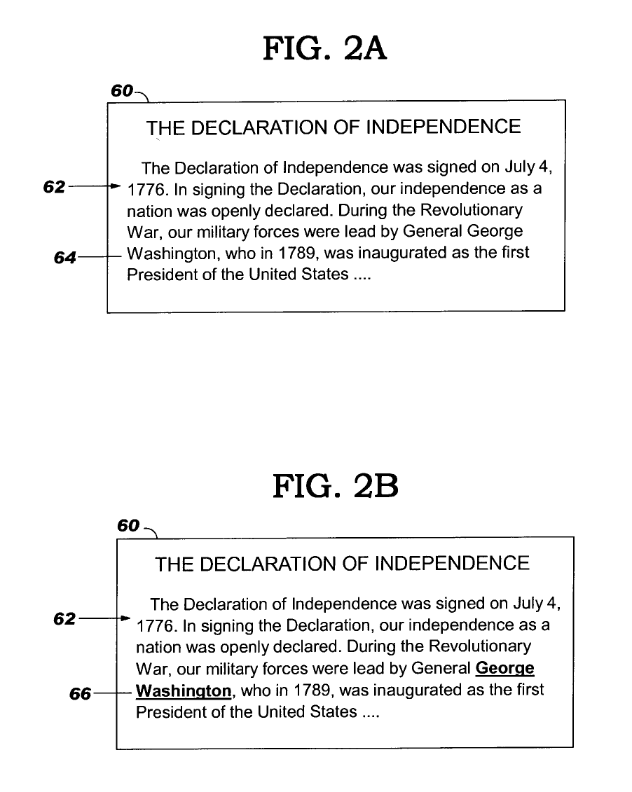

Once a web document has been stored and indexed, it can be linked to other web documents in collection 48 that incorporate as content any of its references. Specifically, user 30 can request a desired web page/document using browser program 24 (e.g., EXPLORER, NETSCAPE, etc.) on user system 22. As the applicable web document is loading, linking system 36 will determine whether it contains any references to other web documents. Specifically, referring to FIG. 2A, an exemplary requested web document 60 having content 62 is shown. As known in the art, content 62 can include text, graphics or a combination of text and graphics. Under the present invention, it is possible for content 62 within requested web document 60 to naturally include one or more references to other related web documents. That is, when creating web document 60, author 32 could have used language that was listed as a reference for another web document. For the purposes of this example, it will be assumed that the name “George Washington” 64 is a reference to another web document (as shown in the above exemplary index). In this event, linking system 36 will convert the “George Washington” reference 64 into a hyperlink 66 to the “George Washington” web document. As shown in FIG. 2B, the reference has been converted into hyperlink 66 to the “George Washington” web document. This conversion typically occurs before web document 60 is displayed to user 30.

It should be understood that although the above index entry lists references that apply to one web document, many variations are possible. Specifically, it is possible for a single reference to apply to multiple web documents (e.g., multiple index entries). For example, authors “A,” “B” and “C” all could have authored web documents that utilize the reference “President.” Thus, if author “D” writes a web document that includes the term “President” within its content, all three web documents apply. In such a scenario, the hyperlink appearing in author “D's” web document when displayed to a user could be a link to a special “link” page. This special “link” page could list the hyperlinks to all three (authors' “A,” “B” and “C”) related web documents. User 30 can then select a particular hyperlink to access its corresponding web document.

Referring back to FIG. 1, the functionality of the present invention is described in greater detail. When a particular web document is requested, document system 40 will access the requested web document. Such access could be achieved by directly retrieving the web document from database 46, or by accessing the web document after retrieval by web program 34. In any event, once the requested web document has been accessed (and while it is loading), determination system 42 will determine whether any related web documents exist. Specifically, determination system 42 will automatically compare the content of the requested web document to the index. If any portion of the content (e.g., a word or phrase) matches any of the references in the index, the matching portion is considered to be a reference to an existing, related document. If no match is established, there are no related documents in existence. In the case of the former (i.e., a related web document does exist), binding system 44 will automatically convert the reference in the requested web document into a hyperlink to the related web document. Specifically, binding system 44 will “bind” the address (e.g., XYZ.123) that corresponds to the matched reference in index 50 to the reference in the requested web document. Then, when the requested web document is finally displayed to user 30, he/she will view the requested web document with the reference shown as a hyperlink (such as hyperlink 66 in FIG. 2B). This process is known as “late binding” because it occurs after the web document/web page is originally created (but prior to display). In the event no match was established (i.e., no related web document exists), the content will remain as originally intended (e.g., plain text) when the web document is displayed to user 30.

By automatically linking web documents in this manner, authors 32 need not be concerned with whether the linked documents exist. Rather, a web document will only be linked to other existing web documents. This allows the group of authors 32 to focus on content creation rather than the technical aspects of web publishing.

It should be understood that although the present invention is typically implemented to allow for content in a web document to naturally/innocently include references to other existing web documents, other variations could exist. For example, Document creation program 28 could provide authors 32 with the capability to “tag” portions (words, phrases, etc.) of content as future or necessary references. For example, if author “A” of a “Declaration of Independence” web document determined that a web document on “George Washington” was needed, he/she could tag the name “George Washington” in his/her web document. Then, if author “B” had not yet created the necessary web document, “George Washington” could be included (e.g., by index system 38) in a list of needed or incomplete web documents. This list could serve as a reminder to authors 32 as to what web documents are missing. In tagging a piece of content as a reference, many variations are possible. For example, an author might enter “<ref>George Washington</ref> became our first President” to tag the term “George Washington” as a reference. If this web document does not yet exist, it could be added to a list of needed web documents. Moreover, when writing a web document, an author could do as follows: “. . . the first <ref key=”George Washington”>President</ref>.” This would create a direct hyperlink from the term “President” to the “George Washington” web document. Again, if the “George Washington” web document has not yet been created, the term “George Washington” could be added to a list of needed web documents.

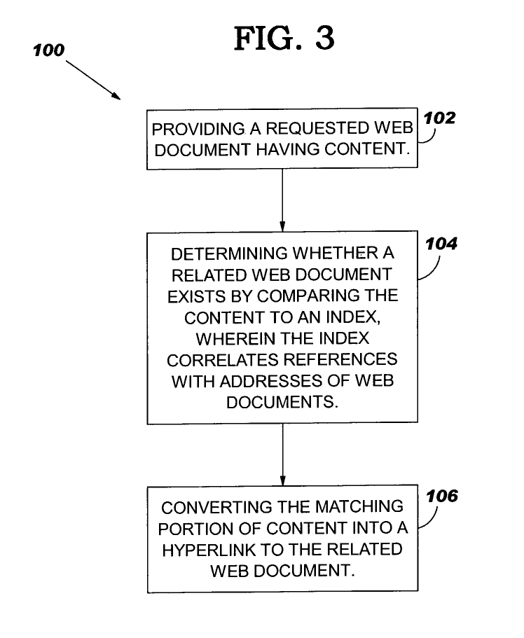

Referring to FIG. 3, a method flow diagram 100 is shown. As depicted, first step 102 is to provide a requested web document having content. Second step 104 is to determine whether a related web document exists by comparing the content to an index while the requested web document is loading, wherein the index correlates references with addresses of web documents. As indicated above, a related web document exists if any portion of the content matches any of the references in the index. Third step 106 is to convert the matching portion of content into a hyperlink to the related web document. As indicated above, this involves binding the address of the related web document to the matching reference (portion of content) in the originally requested web document.

It is understood that the present invention can be realized in hardware, software, or a combination of hardware and software. Any kind of computer/server system(s)—or other apparatus adapted for carrying out the methods described herein—is suited. A typical combination of hardware and software could be a general purpose computer system with a computer program that, when loaded and executed, controls web server 10 such that it carries out the methods described herein. Alternatively, a specific use computer, containing specialized hardware for carrying out one or more of the functional tasks of the invention could be utilized. The present invention can also be embedded in a computer program product, which comprises all the features enabling the implementation of the methods described herein, and which—when loaded in a computer system—is able to carry out these methods. Computer program, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

The foregoing description of the preferred embodiments of this invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of this invention as defined by the accompanying claims.

What is claimed:

1. A computer-implemented method for automatically linking web documents, comprising:
providing a requested web document having content;
determining whether a related web document exists by comparing the content to an index while the requested web document is loading, wherein the index correlates references with addresses of web documents, and wherein the related web document exists if a portion of the content matches any of the references in the index; and
converting the matching portion of content into a hyperlink to the related web document.

2. The method of claim 1, wherein the converting step comprises binding an address of the related web document to the matching portion of content if the related web document exists, prior to displaying the requested web document.

3. The method of claim 2, wherein the address of the related web document is retrieved from the index.

4. The method of claim 1, wherein the content comprises text.

5. The method of claim 1, wherein the references comprise names of the web documents.

6. The method of claim 1, wherein the references comprise topics of the web documents.

7. The method of claim 1, wherein the references comprise unique identifiers corresponding to the web documents.

8. The method of claim 1, further comprising creating the requested web document, prior to the providing step.

9. The method of claim 8, further comprising tagging a portion of the content as a reference, prior to the providing step.

10. A method for automatically linking web documents, comprising:
providing a requested web document, wherein the requested web document comprises content that includes a reference to a related web document;
determining whether the related web document exists by comparing the content to an index while the requested web document is loading, wherein the index correlates references with addresses of related web documents, and wherein the related web document exists if the reference in the requested web page is present in the index; and
converting the reference into a hyperlink to the related web document if the related web document exists, prior to displaying the requested web document.

11. The method of claim 10, wherein the converting step comprises binding an address of related web document to the reference if the related web document exists, prior to displaying the requested web document.

12. The method of claim 11, wherein the address of the related web document is retrieved from the index.

13. The method of claim 10, wherein the content and the reference comprise text.

14. The method of claim 10, wherein the reference comprises a name, a topic or a unique identifier corresponding to the related web document.

15. The method of claim 10, wherein the reference is not converted if the related web document does not exist.

16. The method of claim 10, further comprising creating the requested web document, prior to the providing step.

17. The method of claim 16, further comprising tagging a portion of the content as the reference, prior to the providing step.

18. A system for automatically linking web documents, comprising:
a document system for accessing a requested web document having content;
a determination system for determining whether a related web document exists by comparing the content to an index while the requested web document is loading, wherein the index correlates references with addresses of web documents, and wherein the related web document exists if any portion of the content matches any of the references in the index; and
a binding system for converting a matching portion of content into a hyperlink to the related web document.

19. The system of claim 18, further comprising an indexing system for indexing existing web documents according to corresponding references and addresses.

20. The system of claim 18, wherein the binding system binds an address of the related web document to the matching portion of content.

21. The system of claim 20, wherein the address is retrieved from the index.

22. The system of claim 18, wherein the content comprises text.

23. The system of claim 18, wherein the references comprises names, topics or unique identifiers corresponding to the web documents.

24. A program product stored on a recordable medium for automatically linking web documents, which when executed, comprises:
program code for accessing a requested web document having content;
program code for determining whether a related web document exists by comparing the content to an index while the requested web document is loading, wherein the index correlates references with addresses of web documents, and wherein the related web document exists if any portion of the content matches any of the references; and
program code for converting the matching portion of content into a hyperlink to the related web document.

25. The program product of claim 24, further comprising program code for indexing existing web documents according to corresponding references and addresses.

26. The program product of claim 24, wherein the program code for converting binds an address of the related web document to the matching portion of content.

27. The program product of claim 26, wherein the address is retrieved from the index.

28. The program product of claim 24, wherein the content comprises text.

29. The program product of claim 24, wherein the references comprise names, topics or unique identifiers corresponding to the web documents.
